(19) United States
(12) Patent Application Publication
(10) Pub. No.: US 2015/0094953 A1
(43) Pub. Date: Apr. 2, 2015

(54) SYSTEM FOR LOCATING AND CHARACTERIZING A TOPOGRAPHIC FEATURE FROM A WORK VEHICLE

(71) Applicant: DEERE & COMPANY, Moline, IL (US)

(72) Inventor: James Leonard Montgomery, Dubuque, IA (US)

(21) Appl. No.: 14/044,344

(22) Filed: Oct. 2, 2013

(51) Int. Cl. G01C 21/00; G01C 21/20

(52) U.S. Cl. CPC G01C 21/005; G01C 21/20
USPC 701/514; 701/408

(57) ABSTRACT

The present disclosure relates to a work vehicle having a system for locating and characterizing a topographic feature at a job site. The located topographic feature may be characterized using or more optical instruments, such as a visible-light camera, an infrared-radiation camera, a spectrometer, an infrared thermometer, and a laser-based gas detector. The location and the characteristic of the topographic feature may be combined to produce an informative record of the topographic feature at the job site.

### FIELD

The present disclosure relates to a work vehicle having a system for locating and characterizing a topographic feature.

### BACKGROUND

Work vehicles such as excavation machines find application in the installation, removal, and repair of below and above ground utilities and other structures. Typical below-ground utilities include water mains, sewers, electrical lines, communications lines, subway transit tunnels, water tunnels, and the like.

Below-ground installation of utilities removes the utility lines from the visual appearance of the landscape. To facilitate subsequent repairs or replacements to the hidden utility or to accommodate the installation of additional below-ground utilities and structures in the same vicinity as the hidden utility, engineers make a record of the location of the below-ground utility, as installed. The record may also reflect other sub-surface obstructions. Such locations are recorded on drawings known as “as-built drawings.”

Typically, multiple parties are involved in the production of as-built drawings, which subjects the process to lengthy production schedules and potential human error. A first party may prepare initial or crude as-built drawings in the field. These initial drawings may consist of red-line notations on a copy of the original design drawings, the location of the as-built utility having been established by hand measurements and surveying instruments, for example. A second party may then transfer the first party's initial drawings and notes into a computer aided design tool, such as the program AutoCad™ or similar computer aided design tools, to prepare the finished as-built drawings.

Currently, locating utilities requires placing a global positioning system (GPS) antenna at the location of the utility. However, this process has limited advantages over hand measurements and surveying instruments. Notes of measurements and transfer of the as-built measurements to drawings remains a requirement. Typically, the as-built drawings will be a condition precedent to final payment to a builder or contractor by a utility company or municipality. Furthermore, GPS signals may be obstructed within a below-ground level excavation, or by neighboring building structures or terrain.

In addition to locating utilities at a job site, engineers may perform other manual processes to document the job site. These manual processes may include surveying the job site, taking photographs of the job site, and recording handwritten notes about the job site in a notebook. When welding a joint of a buried gas line, for example, engineers may describe the condition of the joint interfaces and welding test data by hand in a notebook. When repairing a buried steam pipe, for example, engineers may use handheld thermometers to search for leaks and then describe the leak by hand in a notebook. These manual processes are subject to production delays and potential human error.

### SUMMARY

According to an embodiment of the present disclosure, a work vehicle is provided for locating and characterizing a topographic feature at a job site. The work vehicle includes a chassis, a tool moveably coupled to the chassis to move earth at the job site, a controller, a vehicle positioning system in communication with the controller to locate the work vehicle at the job site, a feature locating system in communication with the controller to locate the topographic feature relative to the work vehicle, and a feature characterization system including at least one instrument in communication with the controller to determine at least one characteristic of the topographic feature, the feature characterization system being coupled to the feature locating system for movement therewith relative to the chassis.

According to another embodiment of the present disclosure, a work vehicle is provided for locating and characterizing a topographic feature at a job site. The work vehicle includes a chassis, a tool moveably coupled to the chassis to move earth at the job site, and a controller having software with instructions that, when interpreted by the controller, perform the steps of determining a geographic location point of the topographic feature at the job site, automatically determining at least one characteristic of the topographic feature at the geographic location point, and associating the geographic location point with the at least one characteristic into a record of the topographic feature at the geographic location point.

According to yet another embodiment of the present disclosure, a method is provided for locating and characterizing a topographic feature at a job site from a work vehicle. The method includes the steps of determining a geographic location point of the work vehicle at the job site, determining a geographic location point of the topographic feature relative to the geographic location point of the work vehicle, operating at least one electromagnetic instrument to determine at least one characteristic of the topographic feature at the geographic location point of the topographic feature, and associating the geographic location of point the topographic feature with the at least one characteristic of the topographic feature into a record of the topographic feature.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a side elevational view of an excavation machine equipped with a GPS device for locating the excavation machine and a laser rangefinder for locating a topographic feature;

FIG. 2 is a schematic view of a controller of the excavation machine of FIG. 1;

FIG. 3 is a top plan view of the excavation machine of FIG. 1, further depicting an offset from a reference station;

FIG. 4 is a side elevational view of the excavation machine of FIG. 1 locating a below-ground water main with the laser rangefinder;

FIG. 5 illustrates location of an above-ground fence post with the laser rangefinder;

FIG. 6 illustrates location of a pile of manufactured material for volume measurement with the laser rangefinder; and

FIG. 7 is a perspective view of the laser rangefinder, further including a plurality of optical instruments for characterizing the topographic feature.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

### Introduction

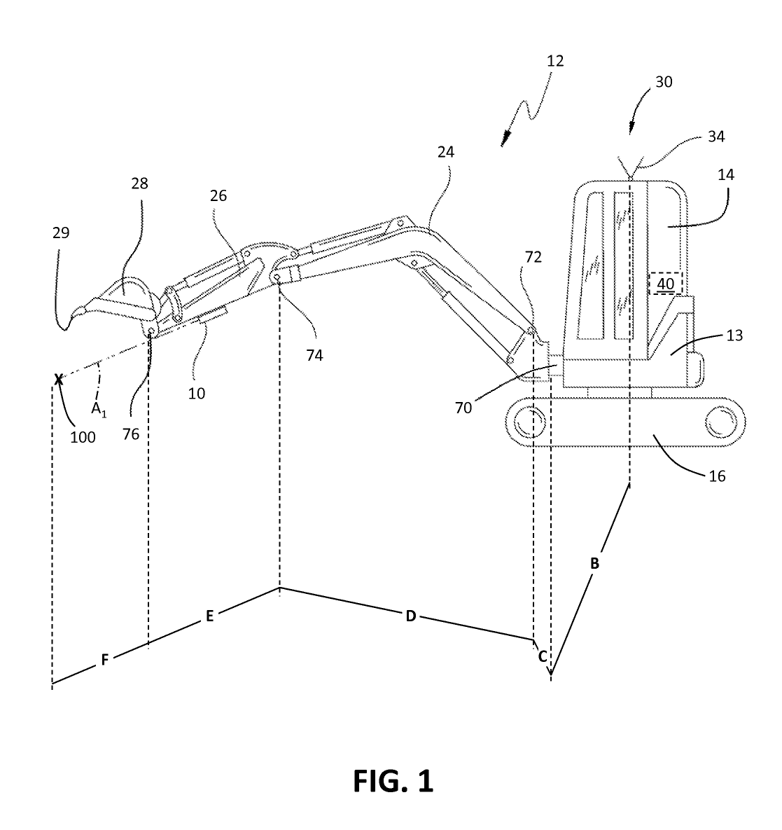

Referring initially to FIG. 1, the present disclosure provides a system for locating and characterizing a topographic feature 100 at a job site from a work vehicle 12. The topographic feature 100 may be positioned at, above, or below the surface of the earth at the job site. Exemplary topographic features 100 include water mains, sewers, electrical lines, communications lines, subway transit tunnels, water tunnels, fence posts, construction materials, and the like.

The work vehicle 12 includes a system for locating the topographic feature 100 at the job site relative to the work vehicle 12. The feature locating system may operate by directing a laser rangefinder 10 on the work vehicle 12 toward the topographic feature 100, or by pointing a tool 28 of the work vehicle 12 at the topographic feature 100, for example. The locating system may interact with a vehicle positioning system for locating the work vehicle 12 itself on the earth, such as by using a GPS device 30 on the work vehicle 12.

The work vehicle 12 also includes a system for characterizing the topographic feature 100. The feature characterization system may be integrated into or associated with the feature locating system. An exemplary feature characterization system includes one or more optical instruments 90 that capture and evaluate electromagnetic radiation from the topographic feature 100, such as visible light, ultraviolet (UV) radiation, or infrared (IR) radiation, to determine an optical characteristic of the topographic feature 100. Suitable optical instruments 90 include a visible-light camera, an IR-radiation camera, a spectrometer, an IR thermometer, and a laser-based gas detector, for example.

The location of the topographic feature 100 from the feature locating system and one or more other characteristics of the topographic feature 100 from the feature characterization system may be combined to produce a combined record of the topographic feature 100. The records may be date-stamped and time-stamped to properly associate information from the feature locating system with coordinating information from the feature characterization system. The combined record may be useful to construction surveyors, contractors, inspectors, and customers. The record collection and production processes may promote convenience, safety, seamless data collection, quality control, and reduced costs at the job site.

### Work Vehicle

Referring still to FIG. 1, the work vehicle is provided in the form of a tracked excavation machine 12. The work vehicle may also be in the form of a wheel-based excavation machine, a tractor-based backhoe machine, or another machine capable of moving surface and below-surface earth at a job site. As shown in FIG. 1, excavation machine 12 includes a chassis 13, an operator cab 14 supported by chassis 13, and a plurality of traction devices, illustratively left-side and right-side tracks 16, configured to propel chassis 13 across the ground. Excavation machine 12 also includes a bucket 28 or another work tool that is moveably coupled to chassis 13 for moving earth at the job site. Between chassis 13 and bucket 28, excavation machine 12 includes a first, boom arm 24 and a second, dipper arm 26 configured to move bucket 28 relative to chassis 13.

### Controller

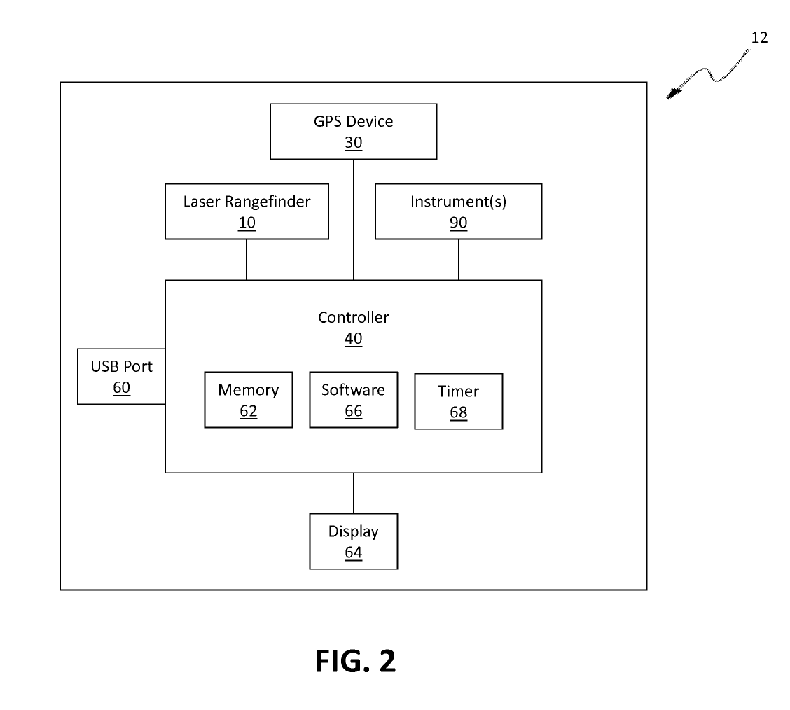

Referring next to FIG. 2, excavation machine 12 also includes an on-board controller 40 that is programmed to handle workspace data, as discussed further below. Controller 40 may also be configured to track and control the operation of excavation machine 12, including boom arm 24, dipper arm 26, and bucket 28 of excavation machine 12 (FIG. 1). Preferably, controller 40 is an appropriately programmed general purpose computer, such as a laptop model. It is also within the scope of the present disclosure that controller 40 may be located off-board or apart from excavation machine 12.

Controller 40 is configured to receive, store, interact with, manipulate, display, and output workspace data. The workspace data may include geographic workspace information obtained from drawings or files of the job site that are constructed via measurements taken by hand, by a GPS device, or otherwise. Such geographic workspace information may include the location of excavation machine 12 at the job site. Such geographic workspace information may also include the location of topographic features 100 (FIG. 1) positioned at, above, or below the surface of the earth at the job site. The geographic workspace information may be presented in the form of drawings or maps, which can be formatted according to any number of known formats, including popular AutoCad™ formats.

As shown in FIG. 2, controller 40 includes a means for inputting workspace data. The means for inputting includes any communication device that allows for workspace data to be provided to controller 40 of excavation machine 12. In the illustrated embodiment of FIG. 2, the means for inputting is a USB port 60 capable of receiving a flash drive having workspace data files thereon. In another embodiment, the means for inputting is a keyboard that allows a user to type in workspace data. In yet another embodiment, the means for inputting is a wireless link or a cellular telephone modem with the ability to download or otherwise receive workspace data. It is within the scope of the present disclosure that controller 40 may include a plurality of different input communication devices.

Controller 40 of FIG. 2 also includes a means for storing workspace data. The means for storing may include a non-volatile memory 62, as shown in FIG. 2. Memory 62 may be internal to controller 40 or external to and removable from controller 40. Memory 62 may overwrite the originally input workspace data with edited workspace data. Also, memory 62 may act based upon a user's save request or automatically after a predetermined time.

Controller 40 of FIG. 2 further includes a means for displaying workspace data. The means for displaying includes any communication device that allows for workspace data to be presented to an operator of excavation machine 12. An exemplary display 64 is a flat screen display tablet located inside operator cab 14 (FIG. 1). However, embodiments are envisioned where display 64 is a heads-up style display where images are projected or otherwise displayed on the windows of operator cab 14. The workspace data may be presented visually on display 64 in the form of drawings or maps, for example.

Controller 40 of FIG. 2 further includes a means for interacting with and manipulating workspace data. The illustrative means for interacting includes a software program 66 on controller 40 that receives and integrates the received and stored workspace data. Software program 66 may be implemented in an iterative fashion such that the workspace data is constantly being reassessed and such that display 64 is constantly being updated. In this way, workspace data may be evaluated and presented in real-time.

In an exemplary embodiment, the software program 66 may interpret the workspace data to provide a visual representation approximating a map or model of the job site. Such a map may include the location of excavation machine 12 at the job site from the positioning system and the locations of various topographic features 100 (FIG. 1) at the job site from the feature locating system. For example, the software may display, in real-time, an icon of excavation machine 12 on a stored map at the appropriate geographic location point of excavation machine 12. The location of implements, such as boom arm 24, dipper arm 26, and bucket 28 may also be shown on display 64 in real-time. Options are provided that allow aerial/satellite maps, such as those obtained from Google Maps or otherwise, to be combined with the workspace data so that a user can more easily correlate map positions with real-world topology of the job site. Such mapping informs the user by providing a visual contextual rendering of excavation machine 12 at the job site and of topographic features 100 at the job-site.

Additionally, the software program 66 may receive and integrate information from the vehicle positioning system, the feature locating system, and the feature characterization system with stored workspace data. This integration may occur by using a clock or timer 68 of controller 40 to identify corresponding workspace data. For example, software program 66 may associate information taken from the feature locating system at a certain time (e.g., 11:30:45 AM) with information taken from the feature characterization system at the same time (e.g., 11:30:45 AM).

In an exemplary embodiment, the software program 66 is able to receive inputs from an operator through port 60, which may be located in operator cab 14 for convenience, and from the vehicle positioning system, the feature locating system, and the feature characterization system. The software program 66 is also able to output workspace data interactions visually onto display 64, which may also be located in operator cab 14 for convenience. Such interactions may take the form of recording the geographic location of the topographic feature 100 in non-volatile memory 62. Such interactions may also involve marking the geographic location of the topographic feature 100 on the map on display 64, such as by selecting a representative symbol or image from a menu on display 64. Such interactions may further involve confirming or correcting the actual or pre-planned geographic location of the topographic feature 100, such as by editing initial design drawings. Additionally, such interactions may take the form of recording a description of the topographic feature 100 in non-volatile memory 62. The complete record of the identity of the topographic feature 100 and precise measurements of the location of the topographic feature 100 are thereby recorded in memory 62 of controller 40, preferably in the form of as-built drawings.

Controller 40 of FIG. 2 further includes a means for outputting workspace data. The means for outputting includes any communication device that allows for workspace data to be downloaded and delivered from controller 40 of excavation machine 12. In one embodiment, the USB port 60 is provided as the means for outputting, as well as the means for inputting. In another embodiment, the means for outputting is a wireless link or a cellular telephone modem with the ability to transmit data, such as via telemetry. In yet another embodiment, the means for outputting is a printer that produces a hard-copy of the edited workspace data. After a topographic feature 100 is properly recorded in controller 40, excavation machine 12 may output the edited workspace data to another computer (not shown), such as the computer of the project manager to support construction documentation or to the customer for billing, for example. The outputted workspace data may be in the form of finalized as-built drawings, as-built drawings requiring consolidation or further editing, or raw data that has yet to be incorporated into as-built drawings.

As shown in FIG. 2, controller 40 communicates with a GPS device 30 of the vehicle positioning system to locate the excavation machine 12 on the earth and with the laser rangefinder 10 of the feature locating system to locate a topographic feature 100 on the earth. Controller 40 also communicates with one or more optical instruments 90 of the feature characterization system. Although not shown in FIG. 2, controller 40 may also communicate with various sensors that monitor movement of boom arm 24, dipper arm 26, bucket 28, swing pin 70, boom pin 72, dipper pin 74, and bucket pin 76, for example. Communication with controller 40 may be hardwired or wireless, such as via a personal area network or “Bluetooth” network. Each of these components is described in more detail below.

### Vehicle Positioning System

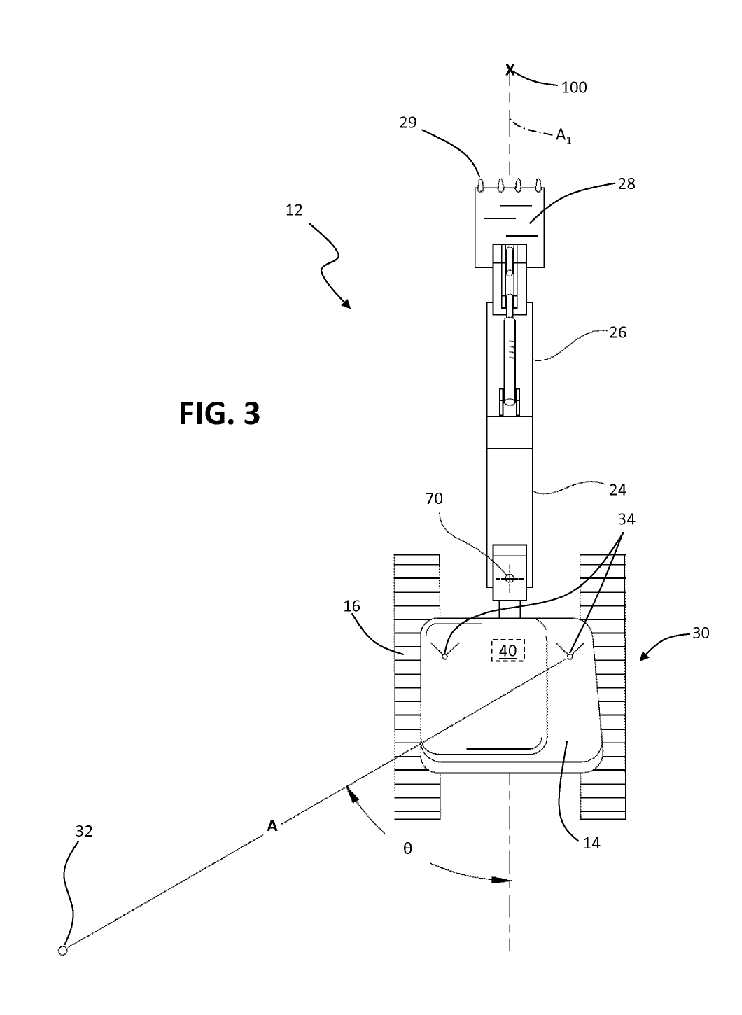

GPS device 30 of the vehicle positioning system is described with reference to FIG. 3. GPS device 30 communicates with controller 40 to determine the geographic location of the excavation machine 12 on the earth. Specifically, GPS device 30 determines the location of a receiving antenna 34, which is mounted at a known location on chassis 13 of excavation machine 12. In this manner, the geographic location of antenna 34 represents the geographic location point of excavation machine 12. When antenna 34 is located, GPS device 30 communicates data related to the geographic location point of excavation machine 12 to controller 40, which may be represented as three coordinates (e.g., X, Y, and Z). Suitable GPS systems affording centimeter-level accuracy are available from Trimble Navigation Limited of Sunnyvale, Calif. GPS device 30 may utilize satellite signals, laser signals, or radio signals, for example.

The present disclosure contemplates excavation machine 12 having multiple GPS antennas 34, as shown in FIG. 3. In addition to determining the location of excavation machine 12, GPS device 30 of FIG. 3 may also determine the orientation of excavation machine 12 (e.g., angle θ) and the direction that excavation machine 12 is facing by comparing the data received from antennas 34. Antennas 34 are illustratively positioned at top forward corners of operator cab 14 of excavation machine 12 in FIG. 3.

For improved accuracy, GPS device 30 may utilize a reference station 32 having a known geographic location, as shown in FIG. 3. In this embodiment, the geographic location point of excavation machine 12 would be determined by measuring a first, variable offset A between the known geographic location of reference station 32 and antenna 34 (which depends on the location of the excavation machine 12 on the excavation job site). An offset is the distance, direction, orientation, and depth (or height) between one feature and another feature. In this case, the first offset A is the distance, direction, orientation, and depth between antenna 34 and reference station 32. Reference station 32 may be located away from the excavation job site (e.g., a “differential GPS” reference station located miles away from the excavation job site), or reference station 32 may be located at or near the excavation job site (e.g., a local positioning station). A typical job-site positioning by laser reference station is provided by Topcon Laser Systems Inc. of Pleasanton, Calif. Accuracy is promoted as a few millimeters.

### Feature Locating System

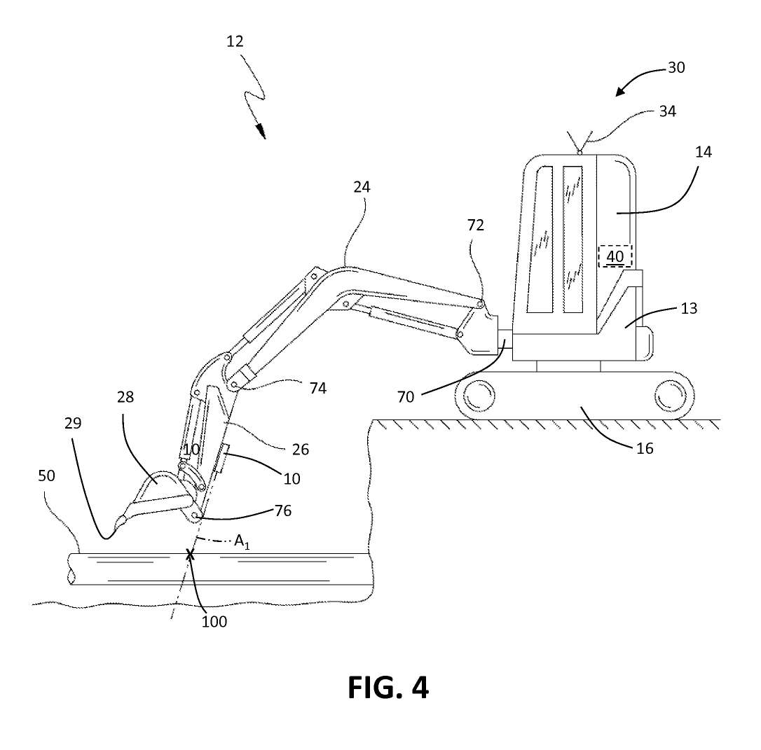

Laser rangefinder 10 of the feature locating system is described with reference to FIGS. 1 and 4. Laser rangefinder 10 communicates with controller 40 to determine the geographic location of a topographic feature 100 relative to excavation machine 12. Topographic feature 100 may be positioned at, above, or below the surface of the earth at the job site. Illustratively, laser rangefinder 10 is mounted on dipper arm 26 of excavation machine 12. Suitable laser rangefinders 10 are available from Laser Technology, Inc. of Centennial, Colo. and Schmitt Measurement Systems, Inc. of Portland, Oreg.

As discussed above with reference to FIG. 3, the first offset A between antenna 34 and the known location of reference station 32 may be measured by software program 66 and stored in memory 62 of controller 40 (FIG. 2). Because the location of GPS antenna 34 on excavation machine 12 is known, additional offsets from antenna 34 to other features may also be determined. When these additional offsets are combined with the GPS-determined geographic location point of excavation machine 12 (i.e., the geographic location of antenna 34), the geographic location point of other features on the earth can be identified in three coordinates (e.g., X, Y, and Z).

Returning to the illustrated embodiment of FIG. 1, for example, controller 40 locates laser rangefinder 10 by evaluating the relative offsets between antenna 34 and laser rangefinder 10. A list of relevant offsets include: a second, fixed offset B between antenna 34 and swing-pin 70; a third, variable offset C between the swing-pin 70 and boom pin 72; a fourth, variable offset D between boom pin 72 and dipper pin 74 (which depends on the length and angle and direction of boom arm 24); and a fifth, variable offset E between dipper pin 74 and the laser rangefinder 10 (which depends on the mount position of laser rangefinder 10 and the angle of dipper arm 26). Fixed parameters may be known by software program 66 of controller 40 (FIG. 2), either by being preset or being input by a user. Such fixed parameters may include, for example, the distance between antenna 34 and swing-pin 70, the length of boom arm 24, and the mount position of laser rangefinder 10 on dipper arm 26.

To establish the offsets from the swing-pin 70 to the laser rangefinder 10, several axes of rotation and optionally a linear extension in the form of the variable extension on dipper arm 26 are encountered. Suitable sensors positioned at each articulation point may be used to detect movement of excavation machine 12.

The first axis of rotation is swing-pin 70. The table of excavation machine 12 may rotate about swing-pin 70, or in the case of a tractor-mounted backhoe, boom arm 24 may rotate about swing-pin 70. In the case of an excavator operable with a rotating table, it may not be equipped with an actual ‘swing-pin’, nonetheless, for purposes of the description herein, such rotating table-type excavators will be discussed as if a swing-pin were present. For rotating table-type excavators, the orientation of boom arm 24 corresponds to the orientation of chassis 13 (e.g., angle θ of FIG. 2). As discussed above, GPS device 30 may be capable of determining the orientation of chassis 13, such as by using multiple antennas 34 on chassis 13. For excavators equipped with an actual swing-pin 70, where the orientation of boom arm 24 varies relative to chassis 13, a rotary encoder at swing-pin 70 may be used at swing-pin 70 to provide data to controller 40 and to determine the direction of boom arm 24.

Other axes of rotation include boom pin 72 (which enables rotation of boom arm 24) and dipper pin 74 (which enables rotation of dipper arm 26). The radial orientation of each axis 70, 72, 74 may be measured by a rotary encoder that is positioned to detect movement about each axis 70, 72, 74. When combined with algorithms appropriate for the individual excavation machine 12, controller 40 can determine the orientation of the boom arm 24, the orientation of the dipper arm 26, and the distance between laser rangefinder 10 and swing-pin (actual or virtual) 70.

For excavation machines 12 equipped with a dipper extension (not shown), a linear encoder and appropriate algorithm provide controller 40 with the additional data required to calculate the position of laser rangefinder 10.

The working environment of excavators may include uneven terrain. Chassis 13 of excavation machine 12 may be oriented such that the pitch and roll of excavation machine 12 deviates from horizontal and vertical. Pitch and roll measurements may be determined by noting the difference in location of multiple antennas 34 mounted on the operator cab 14 or elsewhere on chassis 13. It is also within the scope of the present disclosure that pitch and roll measurements may be determined by inclinometers or other sensors oriented orthogonally and mounted on the operator cab 14 or elsewhere on chassis 13. As a result, controller 40 may also determine the pitch and roll of boom arm 24, dipper arm 26, and laser rangefinder 10 through axes of rotation 70, 72, 74.

Referring still to FIG. 1, the operator may collect real-time data of the geographic location of a topographic feature 100 by orienting the dipper arm 26 in the direction of the topographic feature 100 to be measured and directing a laser beam from the laser rangefinder 10 along axis A₁ toward the topographic feature 100 to illuminate the topographic feature 100. Based on the time required for the laser beam to reflect off the topographic feature 100 and return to the laser rangefinder 10, the laser rangefinder 10 transmits information (e.g., a distance measurement) to the controller 40 which then determines a sixth, variable offset F between laser rangefinder 10 and the illuminated feature 100. To enhance daylight visibility to the operator of the laser rangefinder 10, the laser signal may be enhanced by a second light color such as white or green light. Further enhancement of visibility may optionally be provided by a pattern of a second light color, such as cross-hair.

In an alternative embodiment, the laser rangefinder 10 may be mounted in an alternative position to the dipper arm 26 of the excavation machine 12. A suitable position would be on the chassis 13 of the excavation machine 12 adjacent to the operator cab 14, but the embodiment is not so limited. Preferably the mounting would provide gimbal movement which would permit sighting the laser rangefinder 10 to the illumination target. When coupled with a rotary encoder, the laser rangefinder 10 may be directed to a target to illuminate the topographic feature 100 independent of movement of the boom arm 24, dipper arm 26, or segments thereof. Appropriate offsets from the location of the laser rangefinder 10 and algorithms therefore would be programmed in controller 40 as in the above-discussed embodiment with the laser rangefinder 10 situated on the dipper arm 26. Data related to the sighting direction of the laser rangefinder 10 with respect to the antenna 34 would be provided to controller 40 by rotary encoders on the gimbal mount, which gimbal mount is rigidly connected to the excavator chassis 13. Movement of the gimbal mount may be achieved manually by hand or electronically by a user input (e.g., a joystick) in the operator cab 14, for example.

Upon receipt of data from the laser rangefinder 10, controller 40 collects signals from the rotary encoders, the linear encoder if so equipped, and the GPS device 30. In embodiments having the laser rangefinder 10 mounted on the dipper arm 26, the length of the dipper arm 26 from the dipper axis 74 to the laser rangefinder 10 is essentially arithmetically extended to the illuminated feature 100. The three-dimensional location of the illuminated feature 100 is calculated by combining the offsets B-F with the geographic location point of the excavation machine 12 (i.e., the geographic location of antenna 34) by arithmetic translation and rotation along the linkages using measurements from the aforementioned linear and rotary encoders. If the orientation of the excavation machine 12 deviates from horizontal, then appropriate adjustments of the location for pitch and roll are made to the data for determination of the three-dimensional location of the illuminated feature 100.

Controller 40 may calculate the three-dimensional coordinates of the topographic feature 100 by means of the algorithms programmed for the offsets, the laser rangefinder 10 data, and the job-site positioning data. Or optionally, the raw data may be downloaded for subsequent calculation of the topographic feature 100 location and preparation of as-built drawings, or transmitted to another remote computer (not shown) apart from the excavation machine 12, possibly by recorded media, such as a memory chip, magnetic disk, or wireless means such as a cellular telephone modem for manipulation.

For some applications, determination of the relative location of a topographic feature 100 on the job site is sufficient. The geographic location of the topographic feature 100 on the earth is not warranted, or required. In such instances, the GPS device 30 may be omitted, and the topographic feature 100 may be located with respect to a local job-site reference station 32 or a benchmark surveyed independently of activity related to the excavation job site.

FIG. 4 shows a located sub-surface feature 100 in an excavation, illustratively a point on a water main 50. Controller 40 may then provide the operator the opportunity to manually identify the topographic feature 100 by appropriate description or notation, for example: “buried electrical cable” or, in the illustrated embodiment, “ten inch water main.” The as-built drawing may be edited directly by the operator onboard the excavator by modifying the initial engineering design drawing using controller 40 and display 64 provided.

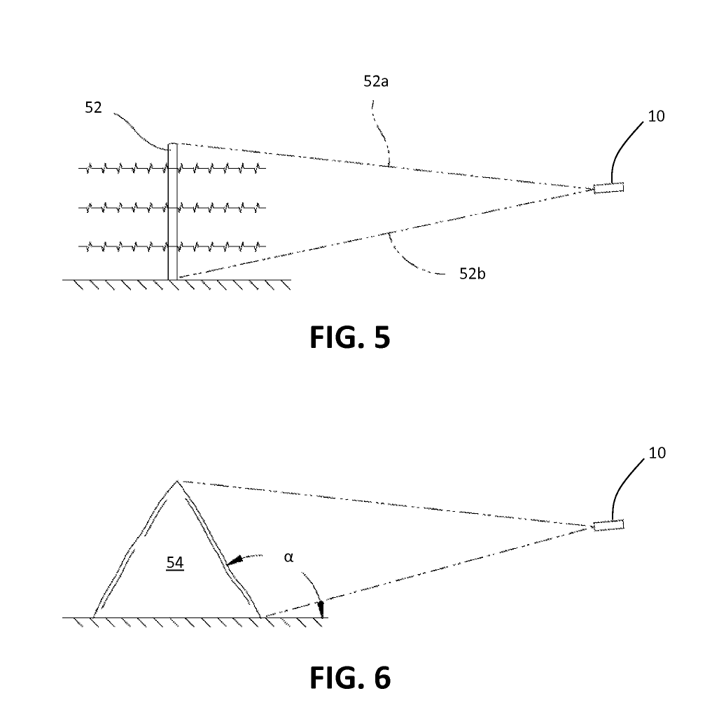

The utility of the onboard measurement is not limited to the location of sub-surface features 100 as heretofore described. As illustrated in FIG. 5, above-ground features 100, illustratively fence post 52, may also be measured by illumination of the structure at different points, such as the top 52a and bottom 52b of a fence post 52. The operator illuminates the top 52a and bottom 52b the fence post 52 and initiates data collection by controller 40 for each illumination 52a, 52b. Advantageously, the operator also manually inputs a notation associated with data collected by controller 40 from the illumination that identifies the data as that of a particular fence post 52. The notation input may be by voice collected by controller 40 by an appropriate microphone, or the notation may be made by traditional keyboard and mouse user interface, or both. The collected data upon manipulation by controller 40 suitably programmed generates the location and height of a fence post 52. The fence post may then be incorporated as a feature and appropriately located, with its associated height, on as-built drawings. If controller 40 is programmed to generate as-built drawings in addition to collecting data therefore, the operator is then afforded the opportunity to see on the display 64 that the feature registers appropriately on the drawings.

A further useful feature is illustrated by FIG. 6. When combined with the common formula for the volume of a right circular cone: V=(πr²h)/3, the altitude of a processed construction material is readily determined, as is the radius either from the angle α of intersection of the cone with a horizontal surface, or the difference of horizontal vectors of the laser illuminated measurements. The excavator operator then may conveniently measure the volume of a cone shaped stockpile 54 such as mined gravel, coal, or grain. The convenience of such a useful feature would enable the operator to collect data to determine a volume of material. It would therefore not be necessary for a separate survey of the stockpile 54 to determine its volume.

The volume of the stockpile 54 thus determined may be recorded in memory 62 of controller 40, or recorded and transmitted to a central location via modem, where an appropriate charge for the stockpile 54 may be made to a customer by a central billing office. With the benefit of transmitted data, immediate and accurate data of a volume of a stockpile 54 delivered, appropriate invoicing of a customer, and cash flow of the vendor may be accelerated. Alternatively, controller 40 may be programmed to manipulate the data collected in a useful form and display the results to the operator. The resulting stockpile 54 volume information could be reported to a customer on site.

In summary, from the combination of the offset A between reference station 32 and the geographic location point of excavation machine 12 (i.e., the geographic location of antenna 34), the offsets B-E between the geographic location point of excavation machine 12 and laser rangefinder 10, and the offset F between the laser rangefinder 10 and the illuminated feature 100, the geographic location of the illuminated feature 100 on the earth (e.g., X, Y, and Z coordinates) may be determined with respect to the reference station 32. As the reference station 32 may be discontinued, and its original location becomes lost, by incorporating GPS data, the geographic location of the topographic feature 100 may be stated and recorded with respect to the earth itself. Advantageously, this location may be determined from the operator cab 14 of an excavation machine 12.

In addition to determining the geographic location of the illuminated feature 100 with the laser rangefinder 10, various physical characteristics of the topographic feature 100 may also be determined with the laser rangefinder 10 by identifying multiple location points, such as: the dimensions of an excavation; the volume of a feature; the height of an above-ground feature; or the slope of a surface, all from the operator cab 14 of excavation machine 12. As illustrated by a simplified example of a right circular cone (FIG. 6), other measurements of angles, slopes, grades and volumes are also readily accomplished.

In another embodiment of the present disclosure, bucket 28 of excavation machine 12 is used to locate topographic feature 100. Specifically, a predetermined tooth tip 29 of bucket 28 is used to locate topographic feature 100 (FIG. 1). Excavation machine 12 need not include a laser rangefinder 10 in this embodiment. In use, the operator of excavation machine 12 places the predetermined tooth tip 29 of bucket 28 as close as possible to topographic feature 100. In other words, the operator uses tooth tip 29 of bucket 28 as a pointer to identify and locate topographic feature 100. This embodiment is described further in U.S. Patent Application Publication No. 2011/0311342, entitled “Three Dimensional Feature Location from an Excavator,” the disclosure of which is expressly incorporated herein by reference in its entirety.

Additional information regarding the vehicle positioning system and the feature locating system of the present disclosure, including the operation of laser rangefinder 10 and controller 40, is found in U.S. Pat. No. 8,363,210, entitled “Three Dimensional Feature Location from an Excavator,” the disclosure of which is expressly incorporated herein by reference in its entirety, and also in the previously-incorporated U.S. Patent Application Publication No. 2011/0311342.

### Feature Characterization System

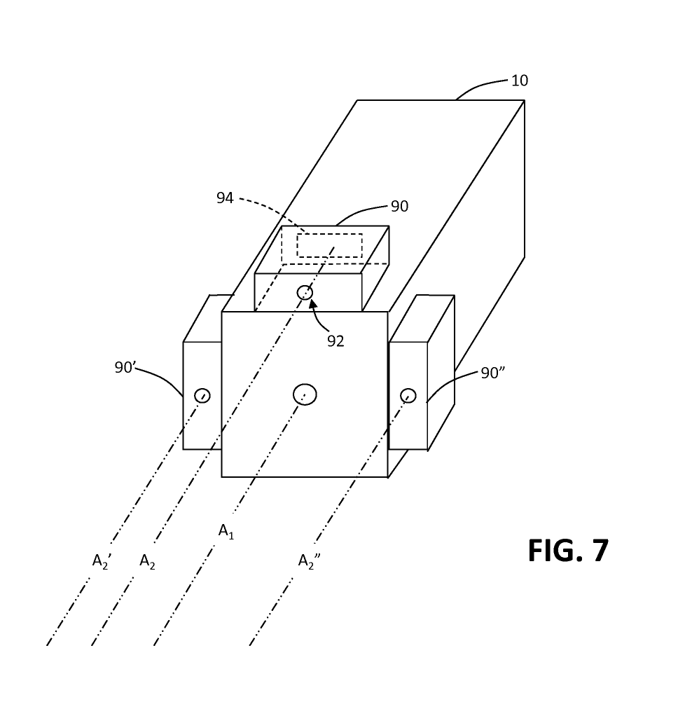

Referring next to FIG. 7, the above-described feature locating system may be enhanced by providing a feature characterization system including one or more optical instruments 90 to further characterize topographic feature 100. The optical instruments 90 may capture and evaluate electromagnetic radiation from the topographic feature 100 to determine an optical characteristic of the topographic feature 100. Exemplary optical instruments 90 include a visible-light camera, an IR-radiation camera, a spectrometer, an IR thermometer, and a laser-based gas detector, each of which is described further below. In FIG. 7, three optical instruments 90, 90′, 90″ are shown spaced around the perimeter of the laser rangefinder 10, but the number, arrangement, size, and type of the optical instruments 90 may vary.

Each optical instrument 90 includes an aperture 92 that receives electromagnetic radiation (e.g., visible light, UV radiation, or IR radiation) along a corresponding instrument axis A₂. Each optical instrument 90 also includes a suitable sensor or detector 94 to capture the electromagnetic radiation that enters aperture 92.

Referring back to FIG. 2, the feature characterization system may operate automatically based on operation of the feature locating system such that the systems operate simultaneously. For example, when the operator fires the laser rangefinder 10 of the feature locating system, such as by pressing a trigger button in operator cab 14 of excavation machine 12, controller 40 may automatically and immediately operate optical instrument 90 of the feature characterization system. The integrated and automated operation of these systems from within operator cab 14 of excavation machine 12 promotes safety, convenience, reduced production times and costs, seamless data collection, and quality control.

The information captured by optical instrument 90 of the feature characterization system may be digitally transmitted to controller 40 for storage, display, and further processing. Controller 40 may associate, correlate, or otherwise combine the information from optical instrument 90 of the feature characterization system with the corresponding location information from the feature locating system to provide a complete digital record of the topographic feature 100 at a certain location point, such as the visual appearance or the temperature of the topographic feature 100 at the location point, and potentially around the location point. For example, controller 40 may use timer 68 to associate time-stamped information taken from the feature locating system at a certain time (e.g., 11:30:45 AM) with time-stamped information taken from the feature characterization system at the same time (e.g., 11:30:45 AM). The ability to operate the feature locating system and the feature characterization system together, as discussed above, may also promote proper overlap of corresponding information.

Returning to FIG. 7, according to an exemplary embodiment of the present disclosure, optical instrument 90 of the feature characterization system is coupled with the feature locating system for movement therewith. In embodiments where laser rangefinder 10 is used to locate topographic feature 100, optical instrument 90 may be configured to move along with laser rangefinder 10. Optical instrument 90 may be mounted directly onto laser rangefinder 10, as shown in FIG. 7. Optical instrument 90 may also be mounted next to laser rangefinder 10 and onto the same vehicle component as laser rangefinder 10. For example, optical instrument 90 may be mounted onto dipper arm 26 of excavation machine 12 next to laser rangefinder 10 (FIG. 1) or onto the above-described gimbal mount on chassis 13 next to laser rangefinder 10 (FIG. 1). In embodiments where bucket 28 is used to locate topographic feature 100, optical instrument 90 may be configured to move along with bucket 28. Advantageously, by tying the movement of optical instrument 90 to the movement of the feature locating system, the operator may use the feature characterization system and the feature locating system together from operator cab 14 without having to maintain or use separate handheld equipment.

According to another exemplary embodiment of the present disclosure, the distance between the instrument axis A₂ and the laser rangefinder axis A₁ may be minimized to reduce offset errors. In certain embodiments, the distance between the instrument axis A₂ and the laser rangefinder axis A₁ may be less than about 5 inches, 3 inches, or 1 inch, for example. One or more of the instrument axes A₂, A₂′, A₂″ may also be parallel with the laser rangefinder axis A₁, as shown in FIG. 7. It is also within the scope of the present disclosure that optical instrument 90 may be incorporated into laser rangefinder 10 with the instrument axis A₂ being coaxial with the laser rangefinder axis A₁, such that the instrument axis A₂ overlaps the laser rangefinder axis A₁. Any separation between the laser rangefinder axis A₁ and the instrument axis A₂ may be negligible or within reasonable operating tolerances, so controller 40 may ignore any such separation and may associate the location point identified along the laser rangefinder axis A₁ with the characteristic determined along the instrument axis A₂. In other words, even though the location point identified along the laser rangefinder axis A₁ may not be exactly the same as the point evaluated along the instrument axis A₂, the two points may be located within an acceptable tolerance, so controller 40 may assume that the two points are the same point. Thus, in addition to determining the location of a certain point, controller 40 may also determine an additional characteristic of the same point, such as the visual appearance or the temperature of the point. The additional characteristic may be determined without having to move the feature locating system to a new location point.

A first suitable optical instrument 90 is a visible-light camera, which captures light in the visible portion of the electromagnetic spectrum. The visible-light camera may include a lens (not shown) positioned near aperture 92 of instrument 90 to focus the light that enters aperture 92 onto the corresponding imaging sensor 94. The imaging sensor 94 may be a charge-coupled device (CCD) imaging sensor that is sensitive in the visible portion of the electromagnetic spectrum. The visible-light camera may operate in a continuous mode to provide video images or in a discrete, frame-by-frame mode to provide still images.

In use, the visible-light camera may be used to generate a record of the visual appearance of the located topographic feature 100. In other words, controller 40 may generate a combined record of the topographic feature 100, including both its geographic location and its appearance at and around that location. In the case of a welded joint of a buried gas line, for example, the combined record may include the geographic location of the joint along with an image of weld data information painted at or next to the joint. Such information would substantially aid surveyors, contractors, and inspectors during the installation and repair of gas lines.

The visual-light camera may also be used to help guide or aim the locating system toward a desired topographic feature 100. For example, based on a known relationship between the camera and the laser rangefinder 10, display 64 could superimpose a graphical marker (e.g., a crosshair) representing the direction of the laser rangefinder axis A₁ onto a real-time image of the surrounding environment from the camera. The operator would then move the laser rangefinder 10 until the graphical marker on the display 64 overlapped the desired topographic feature 100.

Another suitable optical instrument 90 is an IR-radiation camera, which captures radiation in the IR portion of the electromagnetic spectrum. The IR-radiation camera may detect black body radiation that varies as a function of temperature, so the “heat images” captured by the IR-radiation camera may show surface temperatures across the photographed objects. The IR-radiation camera may include a lens (not shown) positioned near aperture 92 of instrument 90 to focus the radiation that enters aperture 92 onto the corresponding imaging sensor 94. The imaging sensor 94 may be a CCD imaging sensor that is sensitive in the near and far IR passbands. The IR-radiation camera may operate in a continuous mode to provide video images or in a discrete, frame-by-frame mode to provide still images. An exemplary IR-radiation camera is the OSXL-E Series Thermal Imager available from OMEGA Engineering, Inc. of Stamford, Conn.

In use, the IR-radiation camera may be used to generate a record of the temperature profile of the located topographic feature 100. In other words, controller 40 may generate a combined record of the topographic feature 100, including both its geographic location and its temperature profile at and around that location. In the case of a steam pipe, for example, the combined record may include a “heat image” identifying a leak in the pipe as a hot-spot along with the geographic location of the leak. In the case of a buried power conductor, for example, the combined record may include a “heat image” identifying an area of large current flow through the conductor as a hot-spot along with the geographic location of the area.

Another suitable optical instrument 90 is an optical spectrometer, which measures properties of light (e.g., wavelength, intensity) and records a spectral signature. The spectrometer may include an optical diffraction grating (not shown) to split and diffract the light that enters aperture 92 into separate beams of different wavelengths and to direct the dispersed beams onto the corresponding imaging sensor 94. The imaging sensor 94 may be a CCD imaging sensor that is sensitive in the visible portion of the electromagnetic spectrum. The location and intensity of the distribution of the dispersed beams onto the CCD imaging sensor 94 is indicative of the intensity of narrow passbands of light. An exemplary spectrometer is the VS140 Linear Array Spectrometer available from HORIBA Scientific of Edison, N.J.

In use, the spectrometer may be used to generate a record of the spectral signature of the located topographic feature 100. In other words, controller 40 may generate a combined record of the topographic feature 100, including both its geographic location and its spectral signature at and around that location. For example, the spectrometer may be used to grade the color of a surface, to estimate the nitrogen and chlorophyll content of a leaf canopy (e.g., a field crop), or to detect the presence of certain gases including methane.

Another suitable optical instrument 90 is an IR thermometer, which receives and measures black body radiation from an object. An IR thermometer may provide a single-spot temperature reading, while an IR camera may provide multiple temperature readings over an area. An exemplary IR thermometer is the TLD100 Thermal Leak Detector available from Black & Decker of New Britain, Conn.

In use, the IR thermometer may be used to generate a record of the temperature of the located topographic feature 100. In other words, controller 40 may generate a combined record of the topographic feature 100, including both its geographic location and its temperature at that location. In the case of a steam pipe, for example, the combined record may identify a leak in the pipe as a location having an unusually high temperature.

Yet another suitable optical instrument 90 is a laser-based gas detector, which transmits a laser light signal toward an object and receives the light signal back from the object through aperture 92. If the light signal interacts with a target gas, such as methane, sensor 94 may detect a change in the returned light signal. Also, the amplitude of the returned light signal may correspond with the concentration of the target gas. An exemplary gas detector is the Enhanced Laser Diode Spectroscopy (ELDS™) Natural Gas/Methane Detector available from Senscient of Houston, Tex.

In use, controller 40 may generate a combined record of the topographic feature 100, including both its geographic location and the presence of any gasses at that location. In the case of a buried storage tank, for example, the combined record may identify a leak in the tank as a location outside of the tank having an unusually high concentration of the target gas.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A work vehicle for locating and characterizing a topographic feature at a job site, the work vehicle including:
a chassis;
a tool moveably coupled to the chassis to move earth at the job site;
a controller;
a vehicle positioning system in communication with the controller to locate the work vehicle at the job site;
a feature locating system in communication with the controller to locate the topographic feature relative to the work vehicle; and
a feature characterization system including at least one instrument in communication with the controller to determine at least one characteristic of the topographic feature, the feature characterization system being coupled to the feature locating system for movement therewith relative to the chassis.

2. The work vehicle of claim 1, wherein the at least one instrument of the feature characterization system is an optical instrument and the at least one characteristic of the topographic feature is an optical characteristic.

3. The work vehicle of claim 2, wherein the optical instrument includes a visible-light camera, an infrared-radiation camera, a spectrometer, an infrared thermometer, or a laser-based gas detector.

4. The work vehicle of claim 2, wherein the optical characteristic includes a visual appearance or a temperature of the topographic feature.

5. The work vehicle of claim 1, wherein the feature locating system and the feature characterization system are coupled to the tool for movement relative to the chassis.

6. The work vehicle of claim 1, wherein the feature locating system and the feature characterization system are gimbally mounted to the chassis for movement relative to the chassis.

7. The work vehicle of claim 1, wherein the feature locating system includes a laser rangefinder.

8. The work vehicle of claim 7, wherein the at least one instrument of the feature characterization system is mounted directly onto the laser rangefinder of the feature locating system.

9. The work vehicle of claim 7, wherein the laser rangefinder of the feature locating system receives electromagnetic radiation along a first axis and the at least one instrument of the feature characterization system receives electromagnetic radiation along a second axis parallel to the first axis.

10. The work vehicle of claim 7, wherein the laser rangefinder of the feature locating system receives electromagnetic radiation along a first axis and the at least one instrument of the feature characterization system receives electromagnetic radiation along a second axis, the first and second axes being separated by less than 5 inches.

11. The work vehicle of claim 1, wherein the feature locating system communicates with the controller to locate the topographic feature based on the position of the tool.

12. The work vehicle of claim 1, wherein the feature locating system includes a plurality of sensors located at articulation points between the chassis and the tool.

13. The work vehicle of claim 1, wherein the controller associates the location of the topographic feature from the feature locating system with the at least one characteristic of the topographic feature from the feature characterization system based on time.

14. A work vehicle for locating and characterizing a topographic feature at a job site, the work vehicle including:
a chassis;
a tool moveably coupled to the chassis to move earth at the job site; and
a controller having software with instructions that, when interpreted by the controller, perform the steps of:
determining a geographic location point of the topographic feature at the job site;
automatically determining at least one characteristic of the topographic feature at the geographic location point; and
associating the geographic location point with the at least one characteristic into a record of the topographic feature at the geographic location point.

15. The work vehicle of claim 14, wherein the controller determines the geographic location point and the at least one characteristic simultaneously.

16. The work vehicle of claim 14, wherein the controller associates the geographic location point and the at least one characteristic based on information from a timer.

17. The work vehicle of claim 14, wherein the controller determines the geographic location point based on movement of the tool relative to the chassis.

18. The work vehicle of claim 14, wherein the record comprises an as-built drawing.

19. The work vehicle of claim 14, wherein the at least one characteristic of the topographic feature is an optical characteristic.

20. The work vehicle of claim 19, wherein the controller determines the optical characteristic by communicating with at least one optical instrument selected from the group consisting of: a visible-light camera, an infrared-radiation camera, a spectrometer, an infrared thermometer, and a laser-based gas detector.

21. A method for locating and characterizing a topographic feature at a job site from a work vehicle, the method including the steps of:
determining a geographic location point of the work vehicle at the job site;
determining a geographic location point of the topographic feature relative to the geographic location point of the work vehicle;
operating at least one electromagnetic instrument to determine at least one characteristic of the topographic feature at the geographic location point of the topographic feature; and
associating the geographic location of point the topographic feature with the at least one characteristic of the topographic feature into a record of the topographic feature.

22. The method of claim 21, wherein the operating step comprises operating one of a visible-light camera, an infrared-radiation camera, a spectrometer, an infrared thermometer, and a laser-based gas detector.
